(19) United States
(12) Patent Application Publication
(10) Pub. No.: US 2026/0238495 A1
(43) Pub. Date: Aug. 13, 2026

(54) CRYPTOGRAPHIC SYSTEM INVOLVING MASKED INVERSION OF RING ELEMENTS

(71) Applicant: PQShield Ltd, Oxford (GB)

(72) Inventors: Thomas ESPITAU, Oxford (GB); Thomas PREST, Oxford (GB); Guilhem NIOT, Oxford (GB)

(21) Appl. No.: 19/638,961

(22) Filed: Apr. 3, 2026

Related U.S. Application Data
(63) Continuation of application No. PCT/GB2024/052575, filed on Oct. 7, 2024.

(30) Foreign Application Priority Data
Oct. 6, 2023 (GB) 2315420.6

(51) Int. Cl. H04L 9/32

(52) U.S. Cl. CPC H04L 9/3255

(57) ABSTRACT

There is described a method of performing a cryptographic operation which includes performing a masked inversion of a ring element f∈R_{q}. where R_{q} is a commutative ring and the ring element f is represented by a plurality of shares [symbol] . The masked inversion is calculated by performing a number theoretic transform on the plurality of shares [symbol] to generate a corresponding plurality of shares [symbol] of a polynomial function a, where each co-efficient [symbol] ∈ [symbol] _{q}; and i∈[n], determining a set of co-efficients corresponding to a product of the n co-efficients for the plurality of shares [symbol] , determining an inverse of the set of co-efficients corresponding to a product of the n co-efficients for the plurality of shares [symbol] , generating a set of co-efficients cᵢ for a plurality of shares [symbol] corresponding to the inverse of the polynomial function a, wherein the i-th co-efficient for a plurality of shares [symbol] is calculated by multiplying a value derived from the inverse of the product of the n co-efficients for the plurality of shares [symbol] by values derived from the other co-efficients for the plurality of shares [symbol] , and for the plurality of shares [symbol] corresponding to the inverse of the polynomial function a, performing an inverse number theoretic transform to generate a plurality of shares [symbol] corresponding to the inverse of the ring element f. By applying the NTT transform to the masked ring element and then determining an inverse of a set of co-efficients corresponding to a product of the masked transformed co-efficients, the processing cost for the inversion of the masked ring element can be reduced.

### CROSS-REFERENCE TO RELATED APPLICATIONS

This application is a continuation under 35 U.S.C. § 120 of International Application No. PCT/GB2024/052575, filed Oct. 7, 2024, which claims priority to GB Application No. 2315420.6, filed Oct. 6, 2023, under 35 U.S.C. § 119(a). Each of the above-referenced patent applications is incorporated by reference in its entirety.

### TECHNICAL FIELD

The present invention relates to an efficient method for performing masked pseudo-inversion of an element f∈ [symbol] _{q}[x], and has particular but not exclusive relevance to rings that are used in lattice-based cryptography.

### BACKGROUND

Lattice-based cryptographic schemes, such as those based on learning with errors (LWE) and short integer solution (SIS) problems, are of interest because lattice-based cryptographic schemes are conjectured to be resistant to attacks by attackers having access to a large-scale quantum computer. Accordingly, lattice-based cryptographic schemes are typically considered to be a subset of post-quantum cryptography.

Lattice-based cryptographic schemes may, however, be vulnerable to side-channel attacks in which an adversary learns side-channel information about the physical execution of an algorithm. The side-channel information may be derived from many sources such as running time, electromagnetic emissions, energy consumption and acoustic emissions. For example, various studies have demonstrated that side-channel information about the execution of lattice-based signing algorithms may allow an adversary to recover the signing key sk that was used.

One countermeasure that has been proposed against side-channel attacks is masking, which relies upon techniques in the fields of secret sharing and multi-party computation (MPC). Given a sensitive value x∈ [symbol] _{q}, masking x consists of representing x as a tuple (x₁, . . . , x_{d})∈

$${ℤ}_{q}^{d} ,$$

where d is the number of shares (also referred to as the sharing order) and in the context of masking d−1 is often called the masking order, such that (i)

$${\sum }_{i = 1}^{d} {x}_{i} = x$$

mod q and (ii) any subset of t<d distinct xᵢ's looks uniformly random. This tuple may be represented by the notation [symbol] _{d} or [symbol] when d is clear in context. The rationale of masking is that an attacker with the ability of learning the value of t<d variables xᵢ will learn nothing about x.

Increasing the value of d strengthens the countermeasure against side-channel attacks, but a challenging aspect of masking is that increasing the value of d often results in the computational complexity scaling with quadratic (or higher) overhead.

Several post-quantum cryptosystems require the determination of an inversion of a ring element f∈R_{q}, where R_{q}∈ [symbol] _{q}[x]/(ψ(x)) and ψ(x)∈ [symbol] _{q}[x] is a monic polynomial. Within the lattice-based family of cryptosystems, examples of such cryptosystems include schemes based on the NTRU class of lattices. In NTRU-based systems, ring elements f, g∈R_{q} are kept secret and the ring element h=f/g is made public. Accordingly, determining the ring elements f, g and h involve the inversion of a ring element. While algorithms for performing masked inversion have been proposed in a number of publications, for example . . . , the complexity of these algorithms is at least in the order of d² multiplications in R_{q}. Since known methods for multiplying two elements in R_{q} involve a processing cost of at least O(d²nlogn), there is a desire for a more efficient manner of calculating a masked inversion of a ring element.

### SUMMARY

According to a first aspect of the present invention, there is provided a method of performing a cryptographic operation which includes performing a masked inversion of a ring element f∈R_{q}. where R_{q} is a commutative ring and the ring element f is represented by a plurality of shares [symbol] . The masked inversion is calculated by performing a number theoretic transform on the plurality of shares [symbol] to generate a corresponding plurality of shares [symbol] of a polynomial function a, where each co-efficient [symbol] ∈ [symbol] _{q}; and i∈[n], determining a set of co-efficients corresponding to a product of the n co-efficients for the plurality of shares [symbol] , determining an inverse of the set of co-efficients corresponding to a product of the n co-efficients for the plurality of shares [symbol] , generating a set of co-efficients cᵢ for a plurality of shares [symbol] corresponding to the inverse of the polynomial function a, wherein the i-th co-efficient for a plurality of shares [symbol] is calculated by multiplying a value derived from the inverse of the product of the n co-efficients for the plurality of shares [symbol] by values derived from the other co-efficients for the plurality of shares [symbol] , and for the plurality of shares [symbol] corresponding to the inverse of the polynomial function a, performing an inverse number theoretic transform to generate a plurality of shares [symbol] corresponding to the inverse of the ring element f By applying the NTT transform to the masked ring element and then determining an inverse of a set of co-efficients corresponding to a product of the masked transformed co-efficients, the processing cost for the inversion of the masked ring element can be reduced.

Not all ring elements are invertible. In an example, in parallel with the determination of the inversion of the masked ring element f, the method may involve calculating for the shares [symbol] of the polynomial function a, the product of the n co-efficients and the inverse of the product of the n co-efficients in order to generate data indicative of whether the ring element f is invertible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows the main components of an example of an electronic messaging system employing a public key cryptosystem.

FIG. 2 schematically shows the main components of a device capable of performing key generation, encryption and decryption operations.

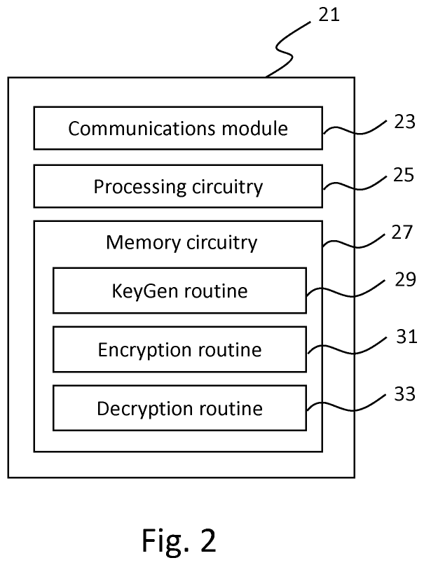

### DETAILED DESCRIPTION

Examples described herein relate to electronic messaging systems in which a sender encrypts an electronic message and a receiver decrypts the encrypted electronic message in accordance with a public key cryptosystem. In the examples given below, the public key cryptosystem is based on the NTRU class of lattices.

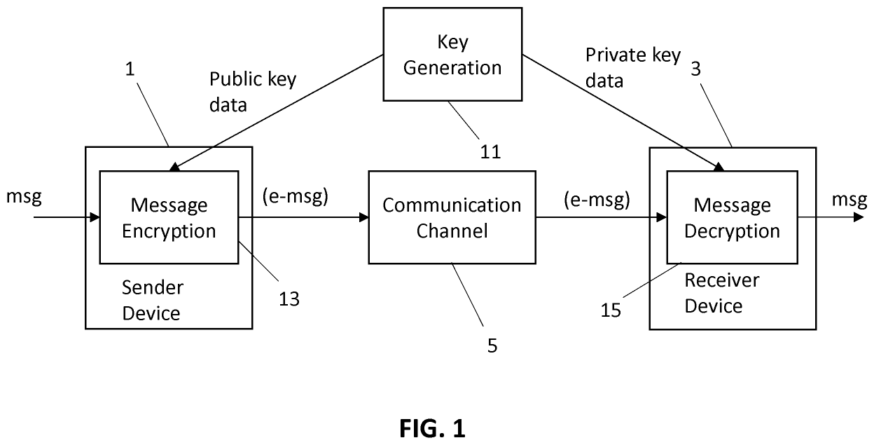

As shown in FIG. 1, an electronic messaging system includes a sender device 1 which sends an encrypted message e-msg to a receiver device 3 vis a communication channel 5.

The sender device 1 is a processing device having a transmitter (not shown in FIG. 1) to transmit the encrypted message into the communication channel 5. For example, the sender device 1 may be a server computer, a desktop computer, a laptop computer, a tablet device or a smartphone. While FIG. 1 shows the sender device 1 receiving a plaintext message msg, alternatively the plaintext message msg may be generated by the sender device 1.

Similarly, the receiver device 3 is a processing device having a receiver (not shown in FIG. 1) to receive an encrypted message from the communication channel 5. For example, the receiver device 3 may be a server computer, a desktop computer, a laptop computer, a tablet device or a smartphone. While FIG. 1 shows the receiver device 3 outputting a plaintext message msg, alternatively the plaintext message msg may be processed by the verifier device 3.

The communication channel 5 may communicate electronic messages over a communication network such as a local area network (LAN), wide area network (WAN), public land mobile network (PLMN), system area network (SAN) or the like. The communication channel 5 may involve the sender device 1 storing the message msg in memory for subsequent retrieval by the receiver device 3.

The electronic messaging system of FIG. 1 has a key generation circuit 11 that generates public key data and private key data. The public key data is provided to the sender device 1, and the private key data is provided to the receiver device 3. Although the key generation circuit 11 is shown external to the receiver device 3 in FIG. 1, it will be appreciated that the key generation circuit 11 may be provided in the receiver device 3, with the receiver device 3 communicating the public key data to the sender device 1, for example via the communication channel 5.

The sender device 1 includes a message encryption circuit 13 which receives the plaintext message msg and outputs the encrypted message e-msg.

The receiver device 3 includes a message decryption circuit 15 which receives the encrypted message e-msg and outputs the plaintext message msg.

The key generation circuit 11, the message encryption circuit 13 and the message decryption circuit 15 may be embodied in hardware, software or a combination of hardware and software. For example, one or more of the key generation circuit 11, the message encryption circuit 13 and the message decryption circuit 15 may comprise a cryptographic coprocessor that accelerates cryptographic operations in a System-on-Chip (SoC) environment on a Field Programmable Gate Array (FPGA) or an Application Specific Integrated Circuit (ASIC).

An example of the operations performed by the key generation circuit 11 will now be described in detail. In this discussion, the following notation will be used:
a vector will be represented in lowercase bold font (e.g. t);
a Matrix will be represented in uppercase bold font (e.g. A);
R_{q} is the base ring, which is commutative and is of the form R_{q}∈ [symbol] _{q} [x]/(ψ(x)) where ψ(x)∈ [symbol] _{q}[x] and is a monic polynomial; the base ring may for example be a quotient ring of the form [symbol] _{q} [x]/(xⁿ+1), where [symbol] _{q}= [symbol] /q [symbol] is the ring of integers modulo q;
the notation x←S means that x is sampled uniformly at random from the set S;

For NTRU based schemes, two secret ring elements f and g are sampled from R_{q}. These ring elements are in the form of polynomials. The secret ring elements f and g form private key data. As a protection against side channel attacks, a masking scheme is employed in which each of the secret ring elements f and g is stored and processed in the form of a plurality of shares, where each share is a member of R_{q}. In particular, the masking of a ring element f consists of representing f as a tuple (f₁, . . . , f_{d}), where d is the number of shares (also referred to as the sharing order) and in the context of masking d−1 is often called the masking order, such that (i)

$${\sum }_{i = 1}^{d} {f}_{i} = f$$

mod q and (ii) any subset of t<d distinct fᵢ's looks uniformly random. This tuple may be represented by the notation [symbol] _{d} or [symbol] when d is clear in context. The rationale of masking is that an attacker with the ability of learning the value of t<d variables x, will learn nothing about x.

A ring element h=f/g is then calculated, with the secret elements f and g being processed in masked format. The ring element h forms public key data.

The calculation of the public ring element h involves the inversion of a ring element in masked format. The manner in which the key generation circuit 11 calculates the inversion of a ring element [symbol] _{d} may be represented by the following pseudocode:

Algorithm 1 PseudoInverse

```
$Require : 〚 f 〛 ∈ {ℛ}_{q}^{d}$
$Ensure : e ∈ \{ 0 , 1 \} , 〚 {f}^{x} 〛 {ℛ}_{q}^{d} such that , if e = 1 , then {f}^{x} = {f}^{- 1}$
  $1 : \begin{matrix}〚 a 〛 := NTT ( 〚 f 〛 ) & ⊳ a = {( {a}_{i} )}_{i ∈ [ n ]} ∈ {ℤ}_{q}^{n}\end{matrix}$
  2: [symbol]  b₋₁ [symbol]  := [symbol] 0 [symbol]
  3: for i ∈ {0, . . . , n − 1} do
  4: [symbol]  bᵢ [symbol]  ← [symbol] aᵢ [symbol]  · [symbol] bᵢ₋₁ [symbol]
```

| | |
|---|---|
| 5: [symbol] tₙ₋₁ [symbol] ← [symbol] bₙ₋₁ [symbol] ^{φ(q)-1} | [symbol] Done via the square-and-multiply algorithm |
| 6: [symbol] bₙ₋₁ [symbol] RefreshScalar ( [symbol] bₙ₋₁ [symbol] ) | [symbol] Refresh before re-use |
| 7: [symbol] e [symbol] := [symbol] tₙ₋₁ [symbol] · [symbol] bₙ₋₁ [symbol] | [symbol] e ∈ {0, 1}, and e = 0 if and only if f is not invertible |
| 8: [symbol] a [symbol] ← Refresh( [symbol] a [symbol] ) | [symbol] Refresh [symbol] a [symbol] before re-use |

9: for (i = n − 1, . . . , 0) do

| | |
|---|---|
| 10: [symbol] cᵢ [symbol] ← [symbol] tᵢ [symbol] · [symbol] bᵢ₋₁ [symbol] | [symbol] cᵢ = aᵢ⁻¹ |
| 11: [symbol] tᵢ [symbol] ← RefreshScalar ( [symbol] tᵢ [symbol] ) | [symbol] Refresh before re-use |
| 12: [symbol] tᵢ₋₁ [symbol] ← [symbol] tᵢ [symbol] · [symbol] aᵢ [symbol] | [symbol] tᵢ = (Π_{j≤i} aᵢ)⁻¹ |

$13 : 〚 c 〛 := {( 〚 {c}_{i} 〛 )}_{i ∈ [ n ]} ⊳ c ∈ {ℤ}_{q}^{n}$
14: [symbol] f^{x} [symbol] := NTT⁻¹ ( [symbol] c [symbol] )
15: return [symbol] e [symbol] , [symbol] f^{x}

[symbol]

Having received the shares [symbol] for the ring element to be inverted, in line 1 the NTT algorithm is performed to transform the shares [symbol] into a domain which will be referred to as the multiplication domain because the multiplication of high order polynomials is more efficient in that domain. In the pseudocode, the transformed ring element is represented by the vector [symbol] , where the coefficients (aᵢ)_{i∈n}∈ [symbol] _{q}.

In lines 2 to 4 of the pseudocode, a set of n products is calculated. In particular, for the field elements [symbol] where i={0, . . . , n−1}, products [symbol] . [symbol] , [symbol] . [symbol] . [symbol] , . . . [symbol] . [symbol] . . . [symbol] are calculated using masked multiplication. In the pseudocode, these products are represented by [symbol] where i={0, . . . , n−1}. In line 5, the inverse [symbol] of [symbol] is calculated. The modular inversion may be performed using Euler's theorem, as shown in line 5, with the exponentiation being efficiently performed using the square and multiply algorithm. It will be noted that only a single inversion operation is performed.

In line 6 of the pseudocode, an optional scalar refresh operation is performed on [symbol] [symbol] in order to prevent the same co-efficients being re-used in order to increase protection against side channel attacks. A refresh operation on data changes the way in which the data is masked by using a different sharing. Refresh gadgets that can perform refresh operations at an efficiency O(dlogd) are widely known.

In line 7 of the pseudocode, a masked multiplication of [symbol] and [symbol] is performed to generate a masked value [symbol] for an element e∈{0,1}. If the ring element f is invertible, then the element e will be 1, whereas if the ring element f is not invertible then the element e will be 0. Accordingly, the element provides an indication of whether or not the ring element f is invertible.

In line 8 of the pseudocode, a further optional refresh operation is performed for the transformed ring element a in order to prevent the same co-efficients being re-used in order to increase protection against side channel attacks.

In lines 9, 10 and 12 of the pseudocode, masked inversions of the field elements of the transformed ring element a are calculated by iteratively performing two sets of masked multiplications, with another optional refresh operation for [symbol] being performed in line 11, to generate co-efficients for a masked form of the inverse of the transformed ring element a.

The operations at lines 2-5, 8-10 and 12 of the pseudocode effectively correspond to a variant of Montgomery's trick in which the inverse of multiple field elements can be determined using a single modular inverse operation. As a simplified example, if there are field elements x₁, x₂ and x₃, then if we calculate the products x₁.x₂ and x₁.x₂.x₃ and calculate the inverse of only the product of all field elements x₁.x₂.x₃, then:

$${( {x}_{3} )}^{- 1} = ( 1 / {x}_{1} \cdot {x}_{2} \cdot {x}_{3} ) \cdot ( {x}_{1} \cdot {x}_{2} )$$

$${( {x}_{2} )}^{- 1} = ( 1 / {x}_{1} \cdot {x}_{2} \cdot {x}_{3} ) \cdot ( {x}_{3} ) \cdot ( {x}_{1} )$$

$${( {x}_{1} )}^{- 1} = ( 1 / {x}_{1} \cdot {x}_{2} \cdot {x}_{3} ) \cdot ( {x}_{3} ) \cdot ( {x}_{2} )$$

Returning to the pseudocode, in line 13 the inverted field elements are collated to generate a masked form [symbol] of a vector corresponding to the inverse of the transformed ring element a. In line 14, an inverse NTT algorithm is performed to generate [symbol] . Finally, in line 15 [symbol] and [symbol] are returned. As explained above, if e=1 then f^{x}=f⁻¹, whereas if e=0 then f is not invertible.

By transforming the masked polynomial [symbol] using the NTT algorithm and then applying a variant of Montgomery's trick introducing masked multiplication and masked inversion operations, the number of arithmetic operations required to perform the masked inversion of the polynomial scales with the number of shares in an efficient manner. For example, for the pseudocode described above, there are two NTT operations (which scale at O(d n log n)), 3n+1 multiplications (which scale at O(n d²)), an exponentiation (which scales at O(d² log q)) and refresh operations (which scale at O(d log d)). Accordingly, the total complexity is O(d(n log n+nd+dlogq+n log d)).

The above example is to be understood as illustrative of the invention. Further examples of the invention are envisaged. For example, the invention has applicability for any cryptographic system that involves the masked inversion of a polynomial, not just NTRU-based schemes. In such cryptographic systems, the invention need not be applied in the key generation algorithm, but could also be applied in other cryptographic algorithms including encryption algorithms, decryption algorithms, signing algorithms and verification algorithms.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of performing a cryptographic operation, wherein the method comprises performing a masked inversion of a ring element f∈R_{q}, where R_{q} is a commutative ring and the ring element f is represented by a plurality of shares [symbol] , by:
performing a number theoretic transform on the plurality of shares [symbol] to generate a corresponding plurality of shares [symbol] of a polynomial function a, where each co-efficient [symbol] ∈ [symbol] _{q}; and i∈[n];
for the plurality of shares [symbol] of the polynomial function a, for N=0 to n−1, iteratively determining a product of N co-efficients for the plurality of shares [symbol] to generate a set of products including a product of the n co-efficients for the plurality of shares [symbol] ;
determining an inverse of the product of the n co-efficients for the plurality of shares [symbol] ;
generating a set of co-efficients cᵢ for a plurality of shares [symbol] corresponding to the inverse of the polynomial function a, wherein the i-th co-efficient for a plurality of shares [symbol] is calculated by multiplying a value derived from the inverse of the product of the n co-efficients for the plurality of shares [symbol] by values derived from the other co-efficients for the plurality of shares [symbol] ; and
for the plurality of shares [symbol] corresponding to the inverse of the polynomial function a, performing an inverse number theoretic transform to generate a plurality of shares [symbol] corresponding to the inverse of the ring element f.

2. The method of claim 1, further comprising calculating for each of the shares [symbol] of the polynomial function a, the product of the n co-efficients and the inverse of the product of the n co-efficients to generate data indicative of whether the ring element f is invertible.

3. The method of claim 1, wherein calculating the i-th co-efficient cᵢ comprises at least one of i) refreshing the values of the product of the n co-efficients for each of the plurality of shares [symbol] and ii) refreshing the values of the co-efficients for the plurality of shares [symbol] .

4. The method of claim 1, wherein the determination of the inverse of the product of the n co-efficients is performed using Euler's theorem.

5. The method of claim 4, wherein the exponentiation of Euler's theorem is performed using the square and multiply algorithm.

6. The method of claim 1, wherein the cryptographic function is a key generation function.

7. The method of claim 6, further comprising encrypting a message using a cryptographic key generated by the key generation function.

8. The method of claim 6, further comprising decrypting a message using a cryptographic key generated by the key generation function.

9. The method of claim 6, further comprising generating a digital signature for a message using a cryptographic key generated by the key generation function.

10. The method of claim 6, further comprising verifying a digital signature for a message using a cryptographic key generated by the key generation function.

11. A computer readable storage medium comprising instructions to perform a masked inversion of a ring element f∈R_{q}. where R_{q} is a commutative ring and the ring element f is represented by a plurality of shares [symbol] , by:
performing a number theoretic transform on the plurality of shares [symbol] to generate a corresponding plurality of shares [symbol] of a polynomial function a, where each co-efficient [symbol] ∈ [symbol] _{q}; and i∈[n];
for the plurality of shares [symbol] of the polynomial function a, for N=0 to n−1, iteratively determining a product of N co-efficients for the plurality of shares [symbol] to generate a set of products including a product of the n co-efficients for the plurality of shares [symbol] ;
determining an inverse of the product of the n co-efficients for the plurality of shares [symbol] ;
generating a set of co-efficients cᵢ for a plurality of shares [symbol] corresponding to the inverse of the polynomial function a, wherein the i-th co-efficient for a plurality of shares [symbol] is calculated by multiplying a value derived from the inverse of the product of the n co-efficients for the plurality of shares [symbol] by values derived from the other co-efficients for the plurality of shares [symbol] ; and
for the plurality of shares [symbol] corresponding to the inverse of the polynomial function a, performing an inverse number theoretic transform to generate a plurality of shares [symbol] corresponding to the inverse of the ring element f.

12. An apparatus comprising processing circuitry and memory, wherein the memory stores instructions which, when executed by the processing circuitry, perform a masked inversion of a ring element f∈R_{q}. where R_{q} is a commutative ring and the ring element f is represented by a plurality of shares [symbol] , by:
performing a number theoretic transform on the plurality of shares [symbol] to generate a corresponding plurality of shares [symbol] of a polynomial function a, where each co-efficient [symbol] ∈ [symbol] _{q}; and i∈[n];
for the plurality of shares [symbol] of the polynomial function a, for N=0 to n−1, iteratively determining a product of N co-efficients for the plurality of shares [symbol] to generate a set of products including a product of the n co-efficients for the plurality of shares [symbol] ;
determining an inverse of the product of the n co-efficients for the plurality of shares [symbol] ;
generating a set of co-efficients cᵢ for a plurality of shares [symbol] corresponding to the inverse of the polynomial function a, wherein the i-th co-efficient for a plurality of shares [symbol] is calculated by multiplying a value derived from the inverse of the product of the n co-efficients for the plurality of shares [symbol] by values derived from the other co-efficients for the plurality of shares [symbol] ; and
for the plurality of shares [symbol] corresponding to the inverse of the polynomial function a, performing an inverse number theoretic transform to generate a plurality of shares [symbol] corresponding to the inverse of the ring element f.
